(19) United States
(12) Patent Application Publication
(10) Pub. No.: US 2004/0210559 A1
(43) Pub. Date: Oct. 21, 2004

(54) Method for control of data compression

(76) Inventor: Jarle Einar Qvigstad, Kolbjoernsvik (NO)

Correspondence Address: ERICSSON INC., 6300 LEGACY DRIVE, M/S EVR C11, PLANO, TX, 75024, US

(21) Appl. No.: 10/480,035

(22) PCT Filed: Jun. 24, 2002
(86) PCT No.: PCT/NO02/00223

(30) Foreign Application Priority Data
Jun. 25, 2001 (NO) 20013190

(51) Int. Cl. G06F 7/00; G06F 17/30

(52) U.S. Cl. 707/2

(57) ABSTRACT

A data compression control method allows sharing of a common data compression entity by a plurality of SNDCP entities belonging to different SNDCP layers operating with LLC unacknowledged mode traffic. In particular, utilizing V.42bis compression, sharing is achieved by re-initializing a common V.42bis compression entity from a currently assigned SNDCP entity with compression parameters associated with currently assigned SNDCP entity. Advantageously, the method includes resetting a shared V.42bis compression entity using the C-INIT primitive before an N-PDU is sent. Similarly, in data decompression, a common decompression entity is made available to a plurality of SNDCP entities operating with unacknowledged mode data traffic. Employing the invention in a node offering data compression/decompression reduces the amount of resources used for data compression/decompression.

### FIELD OF THE INVENTION

The present invention relates to the use of V.42bis data compression entities in a telecommunication system, and particularly to a method of sharing a common V.42bis data compression entity by a plurality of SNDCP entities.

The problem Areas

In a digital mobile telecommunication system, herein exemplified by GPRS, the serving node, e.g. SGSN, typically is capable of handling a large number of concurrent calls or mobile stations (MS). The memory capacity of the serving node can be a limiting factor of the total node traffic when handling data compression, e.g. V.42bis compression. In particular, compression, such as V.42bis compression within the SNDCP layer of a SGSN, will consume memory for each established compression entity, and, hence, also for each tree which is allocated within its respective compression entity.

Referring to the accompanying FIG. 1 illustrating the situation by way of example by referring to GPRS, the SNDCP layer is identified in its correct environment within the GPRS layer structure, showing also the protocol stack used for the payload. For example, IP-packets may constitute the payload.

Referring again to the accompanying FIG. 1 illustrating the situation by way of example by referring to GPRS, it should be noted that one SNDCP layer in the SGSN is connected to one SNDCP layer in the mobile station (MS). Hence, as will be understood by a skilled person in the relevant arts, to handle multiple mobile stations, multiple SGSN protocol stacks may exist in a SGSN.

Furthermore, with reference to FIG. 1 illustrating the situation by way of example by referring to GPRS, it should be noted that a SNDCP layer associated with one mobile station might comprise one or more SNDCP entities. That is, a mobile station may be connected within the SNDCP layer by more than one connection, which is also handled by the SNDCP layer. Further more, a SNDCP entity handles one of the connections within the SNDCP layer. An example of such a multiple SNDCP connection is depicted in the accompanying FIG. 4.

Known Solutions and Problems with These

A know solution according to what has been described above, is disclosed through the ETSI standard 04.65 SNDCP, section 6.6, “data compression”, which among other things states that:

“Data compression is an optional SNDCP feature. Data compression applies to both SN-DATA and SN-UNITDATA primitives. Data compression, if used, shall be found on the entire N-PDU, including the possibly compressed protocol control information. FIG. 8 (of the standard, attached hereto as FIG. 3) shows an example of how the SNDCP functions may be used. Several NSAPIs may use a common data compression entity, that is, the same compression algorithm and the same dictionary. Separate data compression entities shall be used for acknowledged (SN-DATA) and acknowledged (SN-UNITDATA) data transfer. Several NSAPIs may be associated with one SAPI, that is, they may use the same QoS profile.” Accordingly, a V.42bis entity, and, hence, one tree, is allocated for each SNDCP entity or SAPI for acknowledged mode, using large amounts of memory for each SNDCP connection to the mobile.

It will be recognized by a person skilled in the relevant arts that data packets are multiplexed in SNDCP. In a GPRS system, for example, IP packets arriving from the Internet, typically referred to as N-PDUs, are received in the SGSN on numbered NSAPIs (network layer service access point identifiers) belonging to a SNDCP layer. Next, SNDCP delivers SN-PDUs on SAPIs (service point access identifiers) to a LLC layer situated below the SNDCP layer.

As for the example above, but in the opposite direction, for packets travelling from the mobile station and arriving at the SGSN, LLC packet data, typically referred to as SN-PDUs, containing SNDCP PDU segments, are received on the SAPI. Next, these are assembled into a complete N-PDU and sent to towards the Internet.

Now, with reference to FIG. 4, some of the functions that SNDCP shall perform are as follows:

a) Mapping of SN-DATA primitives onto LL-DATA primitives.

b) Mapping of SN-UNITDATA primitives into LL-UNITDATA primitives.

c) Multiplexing of N-PDUs from one or several network layer entities onto the appropriate LLC connection.

d) Establishment, re-establishment and release of acknowledged peer-to-peer LLC operation.

e) Supplementing the LLC layer in maintaining data integrity for acknowledged peer-to-peer LLC operation by buffering and retransmission of N-PDUs.

f) Management of delivery sequence for each NSAPI, independently.

g) Compression of redundant protocol control information (for example, TCP/IP header) at the transmitting entity and the compression at the receiving entity. The compression method is specific to the particular network layer or transport layer protocols in use.

h) Compression of redundant user data at the transmitting entity and decompression at the receiving entity. Data compression is performed independently for each SAPI, and may be performed independently for each is PDP context in a GPRS system. Compression parameters are negotiated between the MS and the SGSN.

i) Segmentation and re-assembly. The output of a compressor function is segmented to the maximum length of LL-PDU. These procedures are independent of the particular network layer protocol in use.

j) Negotiation of the XID parameters between peer SNDCP entities using XID exchange.

Now, referring to the accompanying FIG. 4, the flow through the SNDCP layer of a node will be explained. In the transmit direction, the order of functions are the following:

i. Protocol control information compression

ii. User data compression

iii. Segmentation of compressed information into SN-data or SN-unit data PDUs.

Referring again to the accompanying FIG. 4, in the reception flow, through the SNDCP layer of a node the order of functions are as follows:

iv. Reassembly of SN-PDUs to N-PDU's

v. User data decompression

vi. Protocol control information decompression

In the following, a simplified description of SNDCP-V.42bis communication and operation for LLC unacknowledged mode in an exemplary GPRS system is provided. During call set-up, SNDCP may or may not negotiate compression parameters with a message sent from the mobile station (MS) to a serving GRPS support node (SGSN), or from a SGSN to the MS. The message sent for this purpose is often referred to as an XID-command, to which the other participating side respond by a XID-response. Normally, both the MS and the SGSN will check that enough memory is available in the respective portions of the system for the compression entity, which contains both an expander and a compressor function, before an agreement is made with the other cooperating side to run compression. This can, for example, be done with a “Malloc” (memory allocation) before an XID-command or XID-response, respectively, is sent with compression parameters. At this stage in the call set up procedure, the SNDCP will, or may, send an initial C-INIT command to the data compressor and/or data expander, with the negotiated compression parameters. According to V.42bis, the compression trees, the expander for the received direction and the compressor for the transmitted direction are, due to this C-INIT message, configured according to the negotiated parameters. Particularly, for operation in acknowledged mode, in the received direction from the mobile, in the SGSN a complete SNDCP PDU with compressed data is gathered from possibly multiple SNDCP PDU segments, before sending compressed data to the data expandor with a C-DATA message. In turn, the expandor returns data, but not necessarily all data corresponding to the compressed data which was received. SNDCP will, therefore, order a flushing of data to the expandor with the C-FLUSH message, to get the remaining data from the expandor, which remaining data the data expandor returns with a C-data message. Thereafter, according to the standard procedure for acknowledged mode, the compression entity is re-initialised by the SNDCP entity with a C-INIT message with the same compression parameters to make the expansion tree forget the “previous” handling of the data. The reason for this action is that LLC, in acknowledged mode, may lose SNDCP PDUs or segments of the SNDCP PDU, and it is up to the higher layers above the SNDCP protocol to retransmit data (for example by way of TCP). The data expandor may, therefore, not have retained enough knowledge of the previous SNDCP PDU for an acknowledged mode, since a complete SNDCP PDU may be lost, for example on the “air” interface for the mobile station (MS). In the transmit direction, e.g. from a SGSN to a mobile station (MS), for unacknowledged mode, a complete SNDCP NPDU with uncompressed data is sent to the data compressor with a C-DATA message. In turn, the data compressor returns data, but not necessarily all data corresponding to the uncompressed data which was provided to the data compressor. SNDCP will, therefore, order a flushing of data to the data compressor with the C-FLUSH message to get the remaining data from the compressor, which remaining data the data compressor returns with a C-DATA message. Thereafter, according to the standard for unacknowledged mode, the compression entity is re-initialised with a C-INIT message with the same compression parameters to make the compression tree forget the “previous” handling. The reason for this action is that the LLC in acknowledge mode may lose SNDCP PDUs or segments of the SNDCP PDU, and it is up to the higher layer protocols, typically situated above the SNDCP protocol, to retransmit data (for example by way of TCP). The data compressor may, therefore, not have retained sufficient knowledge of the previous SNDCP PDU for unacknowledged mode, since a complete SNDCP PDU may be lost, for example on the “air” interface to the mobile station (MS).

### OBJECTS OF THE INVENTION

It is an object of the present invention to provide a solution for improved data compression resource utilisation in a digital telecommunication system.

### BRIEF DISCLOSURE OF THE INVENTION

The invention provides a method of sharing a data compressor entity in a digital communication system, as recited in the accompanying independent patent claim 1.

Further advantageous features of the invention are recited in the accompanying dependent patent claims.

### BRIEF DESCRIPTION OF THE DRAWINGS

FIG. 1 is a schematic drawing illustrating a transmission plane view of a typical layered structure of a modem digital mobile communication system;

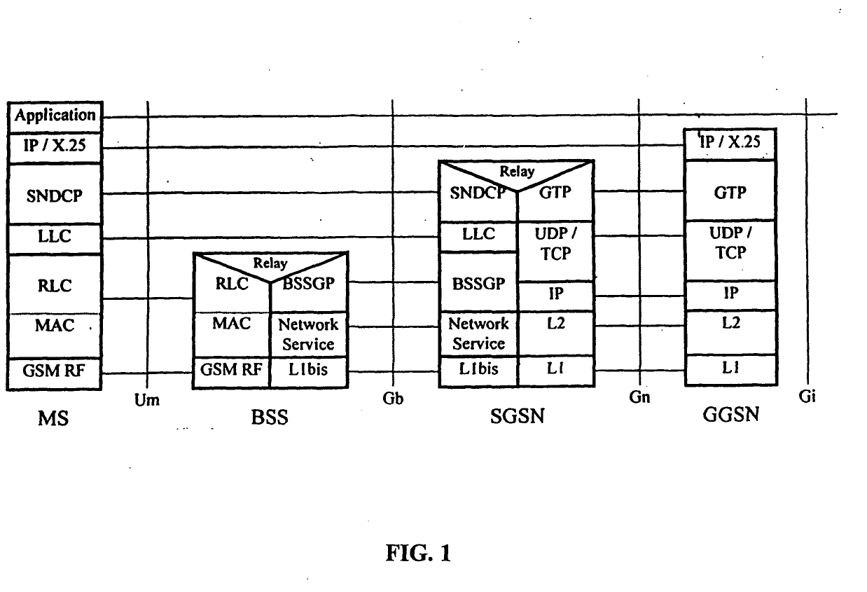

FIG. 2 is a schematic drawing illustrating an exemplary representation of multiplexing of different protocols in the system as illustrated in FIG. 1;

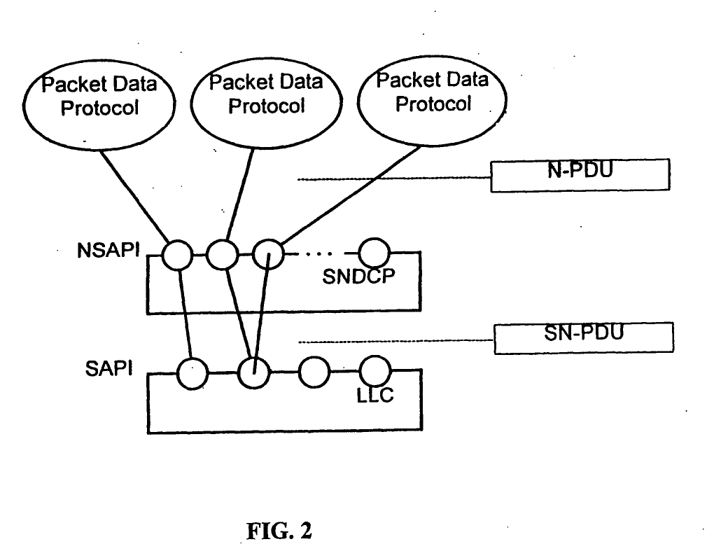

FIG. 3 is a schematic exemplary illustration of usage of NSAPIs, SNDCP functions and SAPIs;

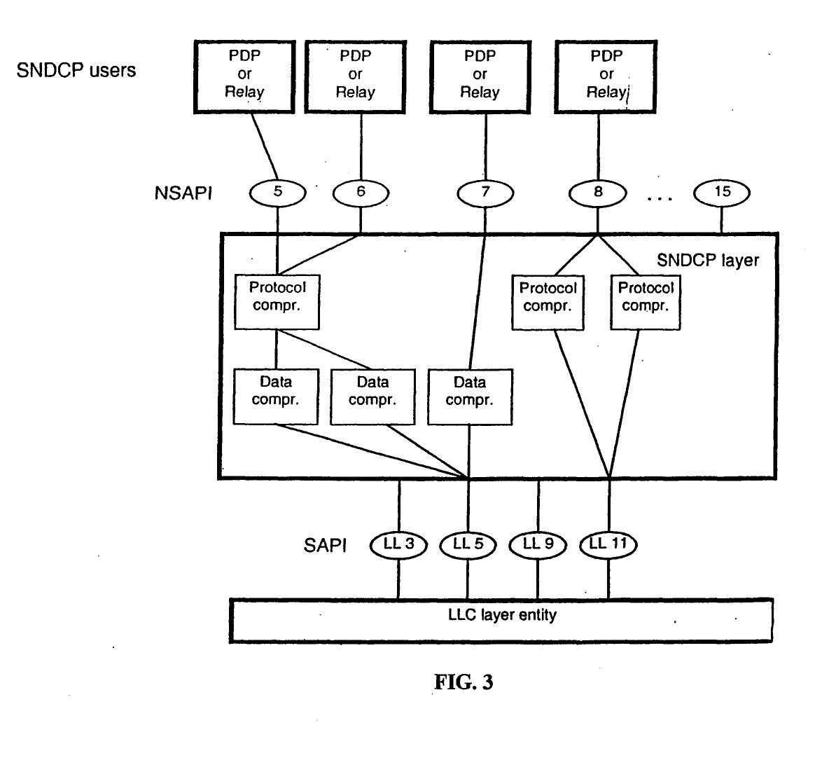

FIG. 4 is a schematic drawing illustrating compression processing for acknowledged mode and unacknowledged mode within the SNDCP layer of a node of an exemplary GPRS system; and

FIG. 5 is a schematic drawing illustrating an exemplary multiplayer SNDCP arrangement employing a common compression entity of the invention. Layer 0 is shown in the example to include a plurality of SNDCP entities.

### DETAILED DESCRIPTION OF EMBODIMENTS

In the following, the invention will be explained by way of example and with reference to the accompanying drawings. In an exemplary GPRS system employing V.42 bis data compression, one V.42 bis data compression function entity suited within the serving node (SGSN) allocates on a processor a memory region sufficient to handle the maximum sized compression tree. All SNDCP connections to different MS's and all their SNDCP entities using LLC unacknowledged mode traffic type reuse the common V.42 bis entity and, therefore, the common V.42 bis tree(s) within this particular V.42 bis entity. For LLC unacknowledged mode, the compression tree is reset after each N-PDU is handled anyway by SNDCP entities. According to the invention the common V.42 bis entity can therefore, dependent of what has been negotiated by the SNDCP entity, in addition be initialised/pre-reset by the SNDCP entity with specific compression parameters using the C-INIT message before each N-PDU. In this way, all SNDCP connections may reuse one common V.42 bis entity and the common compression memory allocated tree with the entity for all SNDCP entity connections in a non-pre-empted, interrupted inhibited or none-interrupted environment for unacknowledged mode. It should be noted that the common V.42 bis entity and respective V.42 bis memory region is shared by all unacknowledged SNDCP entity connections within the same MS, or unacknowledged SNDCP entity connections to different MSs.

The size of the common tree is logically limited to the maximum sizes of SGSN compression parameters supported. If less memory is needed, then only part of the common compression tree memory is used.

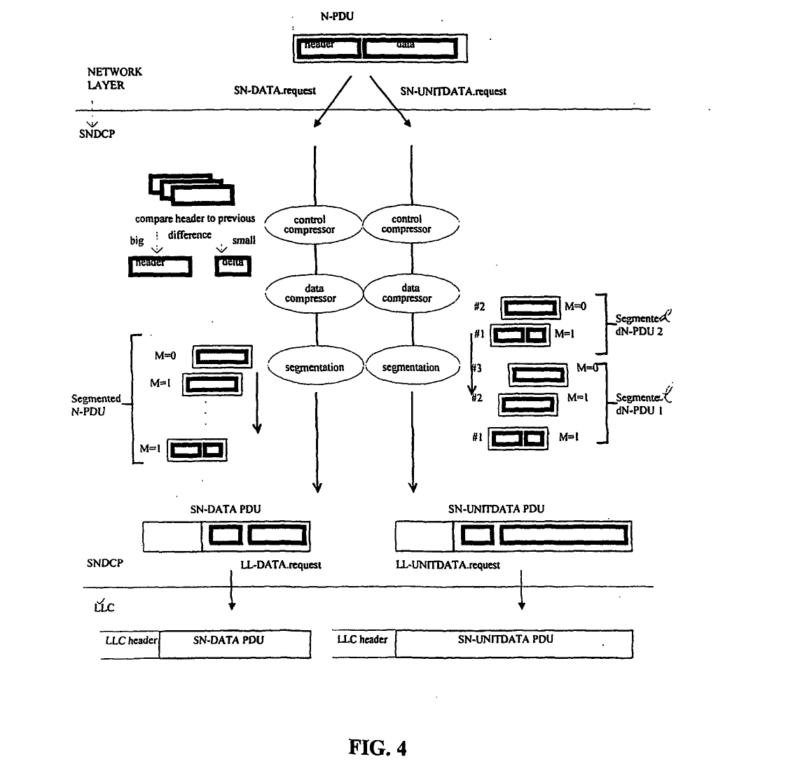

Referring to FIG. 4, the SNDCP protocol is shown in its correct environments, with the common compression tree for LLC unacknowledged mode included. It should be noted that the SNDCP layer exists for each attached mobile. Accordingly, thousands such may exist at any given point in time. The common tree for unacknowledged mode is shared by all SNDCP entities and all SNDCP layers.

In the following referring to a GPRS digital mobile communication system, the invention will be explained by way of example referring to SNDCP V.42 bis communication and operation for LLC unacknowledged mode.

During call setup, SNDCP of a node may, or may not, negotiate compression parameters with a message sent from the MS to SGSN, or from SGSN to MS. The message sent for this purpose is referred to as a XID command, to which the other side will respond with an XID response.

The MS and the SGSN will both normally check that enough memory is available in the respective portions of the system for the compression entity, which typically comprises an expandor as well compressor functions, before agreement is made with the other side to run compression. For example, this can be done with a “malloc” (memory allocation) before the XID command and/or response is sent with compression parameters.

At this stage in the call set-op procedure, the SNDCP will, or may, send an initial C-INIT command to the data compressor and/or expandor with negotiated compression parameters.

According to V.42bis the compression trees the expandor for the receive direction and the compressor for the transmit direction, respectively, are due to the C-INIT message configured according to the negotiated parameters.

At reception of an assembled PDU received from the mobile (see FIG. 4), the compression entity is re-initialised according to the invention by the SNDCP entity with the C-INIT message with SNDCP entity specific compression parameters (see description in a previous section) in order to make the expansion tree forget the “previous action” and relate to negotiated parameters of this particular SNDCP. The reason for this is that the LLC in unacknowledged mode may lose SNDCP PDUs or segments of the SNDCP PDU, and it is up to higher layer protocols, such as for example TCP, situated above the SNDCP protocol layer to effect retransmission of data. The data expandor may, therefore, not have retained sufficient knowledge about the previous SNDCP PDU for unacknowledged mode, since even a complete SNDCP PDU may be lost on the “air” interface from the mobile. Then, for the unacknowledged mode, in the receive direction from the mobile, a complete SNDCP PDU with compressed data is gathered from possibly multiple SNDCP PDU segments before being sent to the data expandor with a C-DATA message. As a result, the expandor returns data, but not necessarily all data corresponding to the compressed data received. SNDCP will therefore order a flushing of data to the expandor with the C-FLUSH message in order to get the remaining data from the expander, which the data the expandor then will return with a C-DATA message. (An additional C-INIT message may also be sent simply to be compliant with the existing standard.)

In the transmit direction to the mobile (see FIG. 4), the compression entity is re-initialised, according to the invention for unacknowledged mode, with the C-INIT message with SNDCP entity specific compression parameters in order to make the compression tree forget the “previous action” and relate to this SNDCP entities negotiated parameters. The reason for this is that LLC in unacknowledged mode may lose SNDCP PDUs or segments of the SNDCP PDU, and it is up to higher layer protocols, like for example TCP, situated above SNDCP protocol layer, to effect retransmission of data. The data compressor may therefore not have retained sufficient knowledge about the previous SNDCP PDU for unacknowledged mode, since a complete SNDCP PDU may by lost on the “air” interface to the mobile. Then, for the unacknowledged mode, in the transmit direction to the mobile, a complete SNDCP PDU with uncompressed data is sent to the data compressor with a C-DATA message. Consequently, the compressor returns data, but not necessarily all data corresponding to the uncompressed data received. SNDCP will, therefore, order to the compressor, with the C-FLUSH message, a flushing of data in order to get the remaining data from the compressor, which the data compressor then will return with a C-DATA message. (An additional C-INIT message may also be sent again simply to be compliant with the existing standard.)

In the following will be explained how the invention relates to the ETSI standard 04.65 SNDCP.

The following is a quote from the above reference standard:

6.6 Data Compression.

Data compression is an optional SNDCP feature. Data compression applies to both SN-DATA and SN-UNITDATA primitives.

Data compression, if used, shall be performed on the entire N-PDU—including the possibly compressed protocol control information. FIG. 8 (of the standard) shows an example how the SNDCP functions may be used. Several NSAPIs may use a common data compression entity, i.e., the same compression algorithm and the same dictionary. Separate data compression entities shall be used for unacknowledged (SN-DATA) and unacknowledged (SN-UNITDATA) data transfer. Several NSAPIs may be associated with one SAPI, i.e., they may use the same QoS profile.

According to the reference quoted above, NSAPIs apparently can already reuse a common compression entity, as it is specified that the entity is related to the compression algorithm and the same dictionary. However, each SNDCP layer has zero, one or more data compression algorithms per SNDCP layer, and there is one SNDCP layer for each mobile. The present invention allows several NSAPIs on the same, or different, SNDCP layers using unacknowledged mode to use a common data compression entity with different, or the same, algorithms on the same physical compression dictionary. That is, the standard should be updated with the present invention, to state that the compression algorithms of en entity can be re-initialised for unacknowledged mode. Hence, it can be made backwards compatible.

Referring to the above quoted section 6.6 of the ETSI standard 04.65 SNDCP, the present invention could be incorporated by changing the standard as follows:

6.6 Data compression.

Data compression is an optional SNDCP feature. Data compression applies to both SN-DATA and SN-UNITDATA primitives.

Data compression, if used, shall be performed on the entire N-PDU, including the possibly compressed protocol control information.

FIG. 8 (of the standard) shows an example how the SNDCP functions may be used. Several NSAPIs may use a common data compression entity, that is, the same compression algorithm and the same dictionary.

For unacknowledged mode, several NSAPIs from different SNDCP layers may use a common data compression entity by re-initialising it with different compression parameters, that is, different compression algorithms and on the same dictionary. Separate data compression entities shall be used for acknowledged (SN-DATA) and unacknowledged (SN-UNITDATA) data transfer. Several NSAPIs may be associated with one SAPI, that is, they may use the same QoS profile.

Furthermore, the present invention is related to the ETSI standard 04.65 SNDCP, as follows:

From the above-identified ETSI standard is quoted as follows:

6.6.2.3 Operation of V.42 bis data compression.

When V.42 bis is used with SN-UNITDATA primitives, the data in the compression entity shall be flushed (using the C-FLUSH primitive and then the compression entity shall be reset, after an N-PDU is sent. The LLC protocol shall operate in the protected mode of operation.

According to the above quoted section 6.6.2.3, the V.42 bis entity must be reset after a N-PDU is sent for unacknowledged mode by the SNDCP entity. The C-INIT primitive, used to reset the compression function, can be sent before the data is provided to the V.42 bis entity, and the C-INIT primitive may contain the connection specific compression parameters for each SNDCP entity. That is, the present invention may be incorporated in the standard preferably by updating the standard to state that the compression entity should be reset before use. Hence, it can be made backwards compatible.

According to what is stated above, incorporation in the above quoted section 6.6.2.3 of the ETSI standard 0.4.65 SNDCP as follows:

6.6.2.3 Operation of the V.42 bis standard compression.

. . .

When the V.42 bis is used with SN-UNITDATA primitives, the data in the compression entity shall be flushed (using the C-FLUSH primitive), and then the compression entity shall be reset, with C-INIT, before and/or after and N-PDU is sent. The LLC protocol shall operate in the protected mode of operation.

. . .

The invention also is related to section 6.10 of the ETSI standard 04.65 SNDCP. Relevant to the above identified standard is section 6.10 as quoted in the following:

6.10 Possible combinations of SNDCP protocol functions and their connection to service access points.

The following combination of SNDCP protocol functions are allowed:

. . .

one data compression entity shall be connected to one SAPI,

Referring to the above quoted section 6.10, the V.42 bis entity (data compression entity) must be connected to only one SAPI which in solutions known prior to the present invention, may be seen as logical. However, considering the present invention this is no longer the case. Considering the present invention, the invention may be incorporated in the above-identified standard by updating the standard to state that the compression entity for unacknowledged mode may be connected to multiple SAPIs. Hence, it will be backwards compatible.

Incorporating the present invention in the ETSI standard 04.65 SNDCP can be made by changing section 6.10 of the standard as follows:

6.10 Possible combinations of SNDCP protocol functions and their connection to service access points.

The following combinations of SNDCP protocol functions are allowed:

. . .

one data compression entity shall be connected to one SAPI for acknowledge mode.

One data compression entity shall be connected to one or more SAPIs for unacknowledged mode.

Advantages

The method of the invention obviates a high demand on memory for unacknowledged mode SNDCP traffic regardless of SAPI in a digital mobile communication arrangement.

Broadening

Although the present invention has been explained with reference to release 97 of the GPRS standard, the invention is not limited by this specific release. The invention also applies to later releases of said standard where the SNDCP layer exists at the Gb-interface and where the V.42 bis compression or other similar data compression exists.

Although the invention is explained with reference to a SGSN in GPRS system, the invention applies equally well to mobile stations (MS). That is, traffic may use the same data compression tree for unacknowledged mode in a non-preemted environment regardless of SAPI.

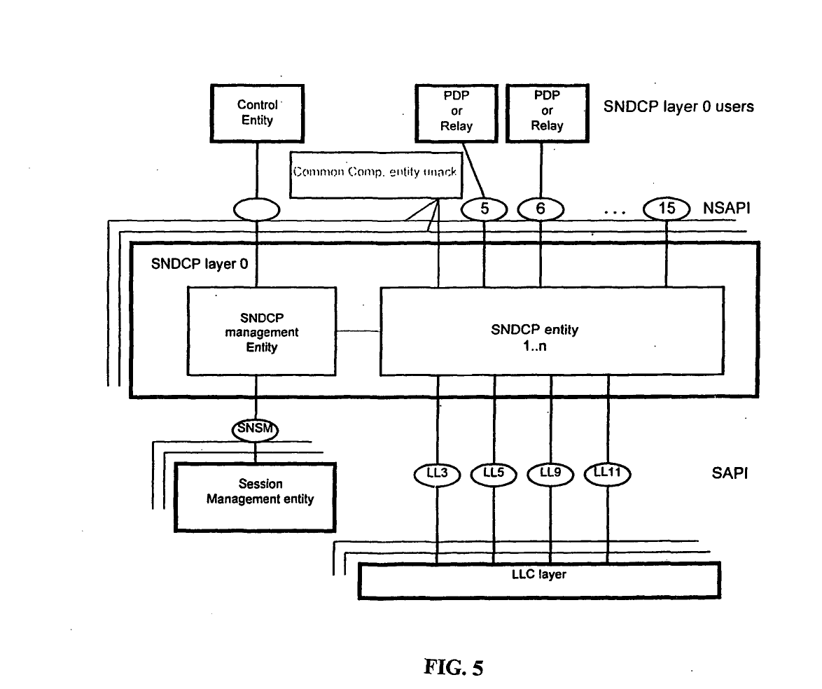

During e.g start-up of a processor in a node, or during the making of the 1^{st} SNDCP layer on a processor in a node, which processor is handling the SNDCP layers, the common compression entity for unacknowledged mode (ref FIG. 5) traffic can be created/installed. This can e.g. be done by means of a function written in the “C” language and defined like this: “extern int Sndcp_v42bis_install_common_comp_entity_for_unack(void)”. When this function is executed in the processor, memory needed for the common compression entity is allocated, and standard V.42bis variables which are to be used by the common compression entity are ready for initialisation. Typically, in known systems, and in contrast to the method of the invention, the creation of a compression entity is done much later during the handling of XID commands and responses.

The common compression entity which is created and installed on the node processor as described by way of example above, typically provides the normal functions for handling the standard messages like C-INIT, C-DATA etc. These functions can also e.g. be defined to be accessible as globally available functions (“extern”), such that all SNDCP layers associated with the processor of the node (i.e. handled by the node processor) can access the common functions that handle the reception of C-INIT, C-DATA and FLUSH commands in the common compression entity. Accordingly, the function of the common compression entity can be accessed from all SNDCP layers by such an “extern” definition.

At the time of XID negotiation, the mode (acknowledged or unacknowledged) of the LLC layer, which is to be running in either acknowledged or unacknowledged mode, is known, and the SNDCP layer at this time exists along with the previously created/installed common compression entity, which is to be used for unacknowledged mode. The SNDCP management Entity (Ref FIG. 5) for each SNDCP layer, which management entity performs the XID negotiation handling, will for unacknowledged mode negotiate compression parameters lower than or equal to the maximum size for the common compression entity. Accordingly, the maximum size for compression parameters can be set to specific maximum values, such as e.g. P1=2048 and P2=20, for the common compression entity. This means that the memory allocated in the “Sndcp_v42bis_install_common_comp_entity_for_unack” function at any time is large enough and sufficient to handle the later incoming traffic, which is to be compressed or decompressed.

During SNDCP entity handling of a (N- or SN-) PDU to be compressed or to be decompressed, the unacknowledged or acknowledged mode is known in the SNDCP entity. The “extern” functions in and provided by the common compression entity (which handles reception of C-INIT, C-DATA and FLUSH messages) on the associated processor shall be called if a PDU which is under processing is related to unacknowledged mode operation.

The method described in the foregoing paragraphs under the heading “broadening” can equally well be applied for allowing the use of a common compression entity for each SAPI (typically the maximum SAPI number limit is set to 4 according to the present standard). Accordingly, a node processor system utilising the invention may include as many common compression entities as there are SAPIs.

1. A method in a GPRS type digital communication system for sharing a V.42bis type data compression entity as a common data compression entity by a plurality of SNDCP entities belonging to different SNDCP layers and operating with LLC unacknowledged mode data packet transfer including data compression of SN-UNITDATA payload data packets, comprising the step of:
associating the common data compression entity with at least two of the plurality of SNDCP entities belonging to different SNDCP layers,
initialising the common data compression entity before compressing each of said SN-UNITDATA payload data packets using a C-INIT primitive with compression parameters negotiated for the SNDCP entity corresponding to the SN-UNITDATA payload data packet to be compressed, and
arranging for uninterrupted compression of the SN-UNITDATA payload data packet to be compressed.

2. The method of claim 1, wherein that the common compression entity is connectable to a plurality of SAPIs for unacknowledged mode data transfer.

3. The method of claim 1 or 2, wherein that the common compression entity includes a code word tree common to said two or more SNDCP entities.

4. The method of claim 3, wherein that initialising said common compression entity effects a reconfiguration of a compression tree of said common compression entity according to predefined and negotiated parameters.

5. The method of any one of claims 2, 3 or 4, claim 2, wherein that the common compression entity is connectable to a plurality of SAPIs for unacknowledged mode.

6. A method in a GPRS type digital communication system for sharing a V.42bis type data decompression entity as a common data decompression entity by a plurality of SNDCP entities belonging to different SNDCP layers and operating with LLC unacknowledged mode data packet transfer including data decompression of SN-UNITDATA payload data packets, comprising the steps of:,
associating the common data decompression entity with at least two of the plurality of SNDCP entities belonging to different SNDCP layers,
initialising the common data decompression entity before decompressing each of said SN-UNITDATA payload data packets using a C-INIT primitive with decompression parameters negotiated for the SNDCP entity corresponding to the SN-UNITDATA payload data packet to be decompressed, and
arranging for uninterrupted decompression of the SN-UNITDATA payload data packet.

7. The method of claim 6, wherein that the common decompression entity is connectable to a plurality of SAPIs for unacknowledged mode data transfer.

8. The method of claim 6 or 7, wherein that the common compression entity includes a code word tree common to said two or more SNDCP entities.

9. The method of claim 8, wherein that initialising said common decompression entity effects a reconfiguration of a decompression tree of said decommon compression entity according to predefined and negotiated parameters.

10. The method of claim 7, wherein that the common decompression entity is connectable to a plurality of SAPIs for unacknowledged mode.

11. The method of claim 6, wherein that the SNDCP layers exist at the Gb-interface of a GPRS communication system.

12. A GPRS type telecommunication node comprising a V.42bis type data compression entity and a plurality of SNDCP entities, said SNDCP entities belonging to different SNDCP layers and operating with LLC unacknowledged mode data packet transfer including data compression of SN-UNITDATA payload data packets,
wherein that the data compression entity is assignable as a common data compression entity to at least two of the plurality of SNDCP entities belonging to different SNDCP layers,
that the at least two of the plurality of SNDCP entities belonging to different SNDCP layers are arranged to initialising the common data compression entity before compressing each of said SN-UNITDATA payload data packets using a C-INIT primitive with compression parameters negotiated for the SNDCP entity corresponding to the SN-UNITDATA payload data packet to be compressed, and
that the node is arranged for uninterrupted compression of the SN-UNITDATA payload data packet.

13. A GPRS type telecommunication node comprising a V.42bis type data decompression entity and a plurality of SNDCP entities, said SNDCP entities belonging to different SNDCP layers and operating with LLC unacknowledged mode data packet transfer including data decompression of SN-UNITDATA payload data packets,
wherein that the data decompression entity is assignable as a common data compression entity to at least two of the plurality of SNDCP entities belonging to different SNDCP layers,
that the at least two of the plurality of SNDCP entities belonging to different SNDCP layers are arranged to initialising the common data decompression entity before decompressing each of said SN-UNITDATA payload data packets using a C-INIT primitive with decompression parameters negotiated for the SNDCP entity corresponding to the SN-UNITDATA payload data packet to be decompressed, and that the node is arranged for uninterrupted decompression of the SN-UNITDATA payload data packet.

14. A method for using a V.42 bis type data compression entity as a common data compression entity for a plurality of SNDCP entities belonging to different SNDCP layers and operating in unacknowledged mode data transfer in a GPRS type telecommunication node for data compression of SN-UNITDATA payload data packets associated with a respective one of said at two or more SNDCP entities, comprising the steps of:
associating said common compression entity with at least two of said plurality of SNDCP entities belonging to different SNDCP layers,
initialising said common data compression entity before data compression of each of said SN-UNITDATA payload data packets using a C-INIT primitive with compression parameters negotiated for the SNDCP entity corresponding to the SN-UNITDATA payload data packet to be compressed, and
arranging for uninterrupted compression of the SN-UNITDATA payload data packet.

15. The method according to claim 14, wherein said common compression entity is connectable to a plurality of SAPIs for unacknowledged mode data transfer.

16. The method according to claim 14 or 15, wherein said common compression entity includes a code word tree common to said two or more SNDCP entities.

17. The method according to claim 14, wherein said initialising of said common compression entity effects a reconfiguration of a compression tree of said common compression entity according to predefined and negotiated parameters.

18. A method for using one V.42 bis type data decompression entity as a common data decompression entity for two or more SNDCP entities belonging to different SNDCP layers and operating in unacknowledged mode data transfer in a GPRS type telecommunication node for data decompression of SN-UNITDATA payload data packets associated with a respective one of said at two or more SNDCP entities, comprising:
associating said common decompression entity with at least two of said plurality of SNDCP entities belonging to different SNDCP layers,
initialising said common data decompression entity before data decompression of each of said SN-UNITDATA payload data packets using a C-INIT primitive with decompression parameters negotiated for the SNDCP entity corresponding to the SN-UNITDATA payload data packet to be decompressed, and
arranging for uninterrupted decompression of the SN-UNITDATA payload data packet.

19. The method according to claim 18, wherein said common decompression entity is connectable to a plurality of SAPIs for unacknowledged mode data transfer.

20. The method according to claim 18, wherein said common decompression entity includes a code word tree common to said two or more SNDCP entities.

21. The method according to claim 18, wherein said initialising of said common decompression entity effects a reconfiguration of a decompression tree of said common decompression entity according to predefined and negotiated parameters.

22. The method according to claim 18, wherein the SN-UNITDATA payload data packet is a N-PDU packet.

23. The method according to claim 18, wherein the SN-UNITDATA payload data packet is a SN-PDU packet.

24. The method according to claim 18, wherein said different SNDCP layers exist at a Gb-interface of said GPRS type telecommunication node.

25. The method of claim 1, wherein that the SN-UNITDATA payload data packet is a N-PDU packet.

26. The method of claim 6, wherein that the SN-UNITDATA payload data packet is a SN-PDU packet.
